(19) United States
(12) Patent Application Publication
(10) Pub. No.: US 2026/0080194 A1
(43) Pub. Date: Mar. 19, 2026

(54) CART-TYPE TERMINAL AND CONTROL METHOD

(71) Applicant: Toshiba Tec Kabushiki Kaisha, Tokyo (JP)

(72) Inventor: Suguru KATO, Sunto Shizuoka (JP)

(21) Appl. No.: 19/210,853

(22) Filed: May 16, 2025

(30) Foreign Application Priority Data
Sep. 17, 2024 (JP) 2024-160347

(51) Int. Cl. G06K 7/14; B60R 16/033; B62B 3/14; B62B 5/00

(52) U.S. Cl. CPC G06K 7/1413; B60R 16/033; B62B 5/0096; B62B 3/14

(57) ABSTRACT

According to one embodiment, a cart-type terminal includes an operator terminal for registration of merchandise, a battery that supplies electric power to the operator terminal, a charging board configured to charge the battery from an external power source connected to a first coupling terminal, and a control unit. The control unit is configured to switch an operating mode of the cart-type terminal apparatus from a normal mode to a power saving mode when the cart-type terminal apparatus is determined to be within a charging area.

### CROSS-REFERENCE TO RELATED APPLICATION

This application is based upon and claims the benefit of priority from Japanese Patent Application No. 2024-160347, filed Sep. 17, 2024, the entire contents of which are incorporated herein by reference.

### FIELD

Embodiments described herein relate generally to a shopping cart-mounted terminal and a control method for cart-mounted terminals.

### BACKGROUND

In related art, there are shopping cart-mounted terminals (cart-type terminals) for registration of merchandise in a sales transaction. It is necessary for these cart-type terminals to be supplied with electric power by on-board batteries or the like and thus to be frequently recharged. For example, the cart-type terminal may be connected to a battery charger provided in a cart storage area of the store to be recharged.

However, sometimes if the charging is not efficiently or quickly performed, the cart-type terminal runs short of electric power during customer operations.

### BRIEF DESCRIPTION OF THE DRAWINGS

FIG. 1 depicts aspects of a cart terminal according to a first embodiment.

FIG. 2 depicts aspects of a cart terminal according to a first embodiment in a side view.

FIG. 3 depicts cart terminals according to a first embodiment in a line.

FIG. 4 depicts aspects of a hardware configuration for a cart terminal according to a first embodiment.

FIG. 5 depicts aspects of a functional configuration of a cart terminal according to a first embodiment.

FIG. 6 is a flowchart of control processing executed by a cart terminal according to a first embodiment.

### DETAILED DESCRIPTION

In general, according to one embodiment, a cart-type terminal apparatus includes an operator terminal for registration of merchandise, a battery that supplies electric power to the operator terminal, a charging board configured to charge the battery from an external power source connected to a first coupling terminal, and a control unit. The control unit is configured to switch an operating mode of the cart-type terminal apparatus from a normal mode to a power saving mode when the cart-type terminal apparatus is determined to be within a charging area.

Certain example embodiments of a cart-type terminal and a control method will be explained with reference to the accompanying drawings. These specifically described embodiments are not intended to limit the configurations, specifications, and the like of other embodiments. In general, various described details may be altered, modified, or varied in other embodiments without departing from the present disclosure.

### First Embodiment

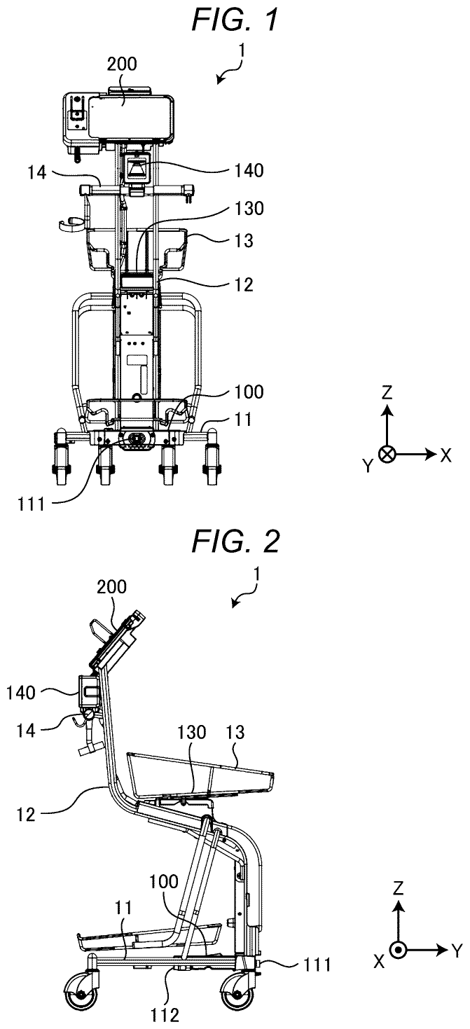

FIG. 1 depicts a front view of a cart terminal 1 according to a first embodiment. FIG. 2 is a side view of the cart terminal 1.

The cart terminal 1 is a shopping cart having an operation terminal 200 for registration of merchandise mounted thereon. The cart terminal 1 is one example of a cart-type terminal, which may also be referred to as a cart-mounted terminal. In this example, the cart terminal 1 has a platform unit 11 with four wheels. The platform unit 11 is formed in a U-shape getting wider going from the front toward the rear. The platform unit 11 is substantially parallel to the floor surface on which the cart terminal 1 moves (rolls). In the platform unit 11, the wheels are provided in two pairs, on pair at the front and one pair at the rear. The cart terminal 1 has a columnar support unit 12 on the platform unit 11. The columnar support 12 is substantially vertical to the floor surface (and thus the platform unit 11)

The support unit 12 supports a holder 13, a handle portion 14, and the operation terminal 200. The holder 13 is a base for holding a shopping basket into which merchandise can be put by the customer or the like. The handle portion 14 is a handle that can be gripped by an operator such as the customer.

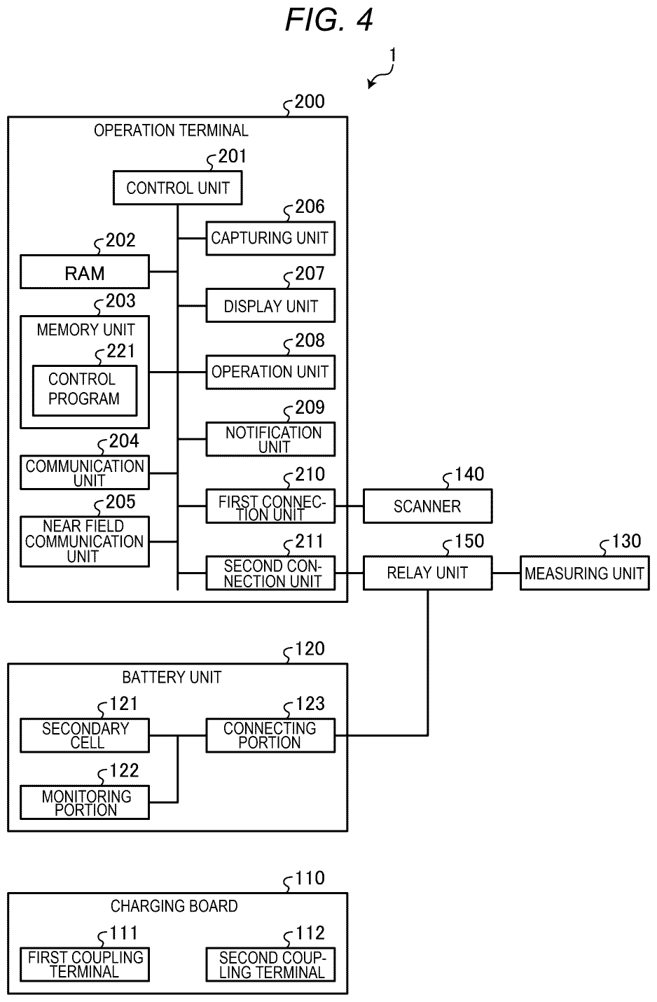

The cart terminal 1 has a charger 100 on the platform unit 11. The charger 100 is a device that charges a secondary cell 121 (see FIG. 4) that supplies electric power to the other parts of the cart terminal 1. The secondary cell 121 may be referred to as a battery in some contexts. The charger 100 has a first coupling terminal 111 and a second coupling terminal 112 (see FIG. 2).

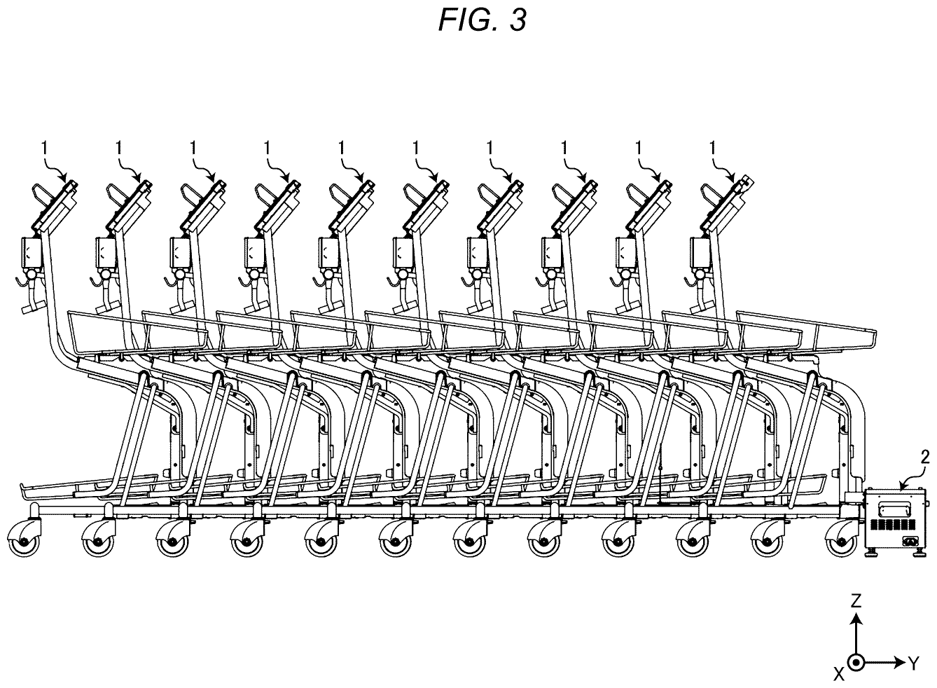

The first coupling terminal 111 is provided at the front side (side facing in positive Y-direction in FIG. 2) of the cart terminal 1. When connected to an external power supply, such as another cart terminal 1 to the front or a power supply device 2 (see FIG. 3), the first coupling terminal 111 receives electric power from the external power supply. For example, the first coupling terminal 111 is a pin-type connector to be inserted into a corresponding socket on an external power supply.

The second coupling terminal 112 is at the rear side (side facing in negative Y-direction in FIG. 2) of the cart terminal 1. The second coupling terminal 112 can provide electric power to another cart terminal 1 to the rear of (behind) the cart terminal 1. For example, the second coupling terminal 112 is a socket into which the first coupling terminal 111 of another cart terminal 1 can be inserted.

In this example, the cart terminal 1 has a measuring unit 130 that measures the weight of merchandise put in the holder 13. The cart terminal 1 executes merchandise registration processing of registering merchandise to be purchased by a user of the cart terminal 1. In this processing, the cart terminal 1 compares the expected weight of the merchandise registered in the merchandise registration processing to the weight of the merchandise in the holder 13 as measured by the measuring unit 130. In this manner, the cart terminal 1 reduces the chance that merchandise different from the merchandise registered in the merchandise registration processing will be put in the holder 13 in error or maliciously.

The cart terminal 1 has an operation terminal 200 supported by the support unit 12. The operation terminal 200 can be a device such as a tablet terminal or a smartphone. The operation terminal 200 executes the merchandise registration processing for registering merchandise being sold. For example, the operation terminal 200 displays a screen image and/or user interface related to the merchandise registration processing. The operation terminal 200 accepts the user input operations related to the merchandise registration processing or otherwise.

A scanner 140 is a device that can read a code symbol such as a barcode or a two-dimensional code. For example, the scanner 140 reads a barcode attached to merchandise.

When a plurality of the cart terminals 1 are longitudinally coupled via the respective chargers 100, electric power supplied between the cart terminals 1 to one another. In this context, longitudinally coupled means arranged in a line, front to rear, with the first coupling terminal 111 of the rearward cart connected to the second coupling terminal of the frontward cart.

FIG. 3 shows an example of a plurality of longitudinally coupled cart terminals 1. For example, the plurality of cart terminals 1 are arranged in a line via the chargers 100 in a cart storage area of the store. Then, the plurality of cart terminals 1 can be charged via the chargers 100 when in the cart area.

The charger 100 of each cart terminal 1 has the first coupling terminal 111 at the front side and the second coupling terminal 112 at the rear side. The first coupling terminal 111 of the cart terminal 1 at the head of the line can be coupled to power supply device 2. The power supply device 2 is connected to an external power supply or a wall outlet. The power supply device 2 supplies electric power to the cart terminal 1 at the head of the cart line when the first coupling terminal 111 is connected to the power supply device 2.

The first coupling terminal 111 of the second cart terminal 1 in the line behind the head cart is coupled to the second coupling terminal 112 of the head cart terminal 1. The head cart terminal 1 supplies electric power to the second cart terminal 1 via the second coupling terminal 112. In this manner, all the longitudinally coupled cart terminals 1 can be respectively charged with electric power.

As described above, the cart terminals 1 are charged when in the cart storage area. In other words, if not placed in the cart storage area, the cart terminal 1 is not recharged. Accordingly, whenever cart terminal 1 is in the cart storage area it is necessary that recharging be efficiently carried out.

FIG. 4 shows a hardware configuration of a cart terminal 1. The cart terminal 1 has a charging board 110, a battery unit 120, a measuring unit 130, a scanner 140, a relay unit 150, and an operation terminal 200.

The charging board 110 is a circuit board or the like on which the first coupling terminal 111 and the second coupling terminal 112 are provided. For example, the charging board 110 is housed inside the charger 100 (see FIG. 1). However, in other examples, the charging board 110 may be housed inside the operation terminal 200 rather than in the charger 100.

The battery unit 120 has the secondary cell 121 (battery cell), a monitoring portion 122, and a connecting portion 123. The secondary cell 121 is a battery cell to be charged with electric power supplied via the first coupling terminal 111. The secondary cell 121 ultimately supplies electric power to the respective sub-units of the cart terminal 1 including the operation terminal 200, the relay unit 150, and the measuring unit 130.

The monitoring portion 122 is an IC (Integrated Circuit) unit that monitors the state of the secondary cell 121. For example, the monitoring portion 122 monitors the remaining amount of charge in the secondary cell 121.

Furthermore, the monitoring portion 122 monitors whether the secondary cell 121 is presently being charged. For example, the monitoring portion 122 determines whether the secondary cell is being charged by monitoring a state of the first coupling terminal 111 and/or a voltage and a current of a wire connected to the first coupling terminal 111.

The connecting portion 123 is an interface connected to the relay unit 150. For example, the connecting portion 123 is connected to the relay unit 150 via a plug and cable based on a USB (Universal Serial Bus) standard. The connecting portion 123 transmits a monitoring result of the battery unit 120 to the relay unit 150. That is, the connecting portion 123 transmits charging state information indicating the remaining amount of charge and the charging state of the secondary cell 121 to the relay unit 150. For example, the charging state is a state indicating whether the secondary cell is connected to an external power supply via the first coupling terminal 111. In this context, an external power supply refers to the charger 100 of another cart terminal 1 to the front, the power supply device 2, or otherwise.

The measuring unit 130 measures the weight of an article put in the holder 13. For example, the measuring unit 130 is a sensor such as a load cell.

The scanner 140 reads a code symbol. For example, the scanner 140 reads a code symbol encoding a merchandise code provided for identification of merchandise associated with the code symbol.

The relay unit 150 connects the operation terminal 200 to external units. For example, the relay unit 150 is a device such as an USB hub. More specifically, in the present example, the relay unit 150 connects the battery unit 120 to the operation terminal 200 and the measuring unit 130 to the operation terminal 200. Note that, if the operation terminal 200 has sufficient direct connecting elements, the operation terminal 200 may be directly connected to the battery unit 120 rather than via the relay unit 150.

The operation terminal 200 includes a control unit 201, a RAM (Random Access Memory) 202, a memory unit 203, a communication unit 204, a near field communication unit 205, a capturing unit 206, a display unit 207, an operation unit 208, a notification unit 209, a first connection unit 210, and a second connection unit 211. These respective units are connected to each other via an internal bus or the like.

The control unit 201 is a processor such as a CPU (Central Processing Unit) that controls operations of the operation terminal 200. The RAM 202 is a storage medium that temporarily stores various programs and various data. The control unit 201 executes a control program 221 and the like stored in the memory unit 203 with the RAM 202 as a work area.

The memory unit 203 is an auxiliary memory device such as an HDD, an SSD, or a flash memory. For example, the memory unit 203 stores the control program 221. The control program 221 is a software program or the like that may work in conjunction with an operating system of the operation terminal 200. The control program 221 includes a program for fulfillment of the characteristic functions according to the embodiment.

The communication unit 204 is a communication device such as a network interface card.

The near field communication unit 205 is a communication device that executes near field communication such as by Wi-Fi or Bluetooth®. Further, the near field communication unit 205 may be a RFID (Radio Frequency Identification) communication device. That is, the near field communication unit 205 may be a device that reads identification information from an RF tag.

The capturing unit 206 is a digital camera having an imaging device such as a CCD (Charge Coupled Device) or a CMOS (Complementary Metal Oxide Semiconductor) imaging device. For example, the capturing unit 206 captures an image of a code symbol such as a barcode or a two-dimensional code.

The display unit 207 can be a display device such as a liquid crystal display or an organic EL display.

The operation unit 208 is an input device that accepts various user input operations. For example, the operation unit 208 is a hardware button or a touch panel provided in conjunction with the display unit 207.

The notification unit 209 gives a notification of the charging state of the secondary cell 121. For example, the notification unit 209 is realized by an LED (Light Emitting Diode). More specifically, the notification unit 209 gives a notification by changing output color according to the charging state. For example, the notification unit 209 emits red light when the secondary cell 121 is still being charged, and emits green light once the charging is completed.

The first connection unit 210 is an interface connected to the scanner 140. For example, the first connection unit 210 is connected to the scanner 140 according to a USB standard.

The second connection unit 211 is an interface connected to the relay unit 150. For example, the second connection unit 211 is connected to the relay unit 150 according to a USB standard.

Next, certain functions of cart terminal 1 will be explained.

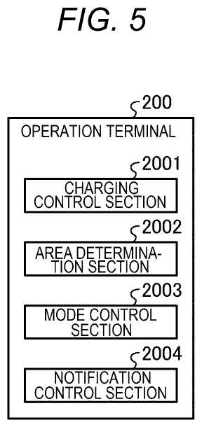

FIG. 5 is a block diagram showing an example of a functional configuration of a cart terminal 1 according to a first embodiment. The control unit 201 of the cart terminal 1 loads the control program 221 stored in the memory unit 203 in the RAM 202 and operates according to the control program 221, and thereby, generates respective functional sections in the RAM 202 or otherwise. Accordingly, the control unit 201 of the cart terminal 1 can be considered to provide the below described functions of a charging control section 2001, an area determination section 2002, a mode control section 2003, and a communication control section 2004.

The charging control section 2001 controls the battery unit 120 to control charging of the secondary cell 121. More specifically, the charging control section 2001 determines whether the secondary cell 121 is presently coupled to an external power supply via the first coupling terminal 111 based on the charging state information received from the battery unit 120. That is, the charging control section 2001 detects whether the secondary cell 121 is coupled to the charger 100 of another cart terminal 1 placed at the front side of the device itself or to a power supply device 2. Then, if the secondary cell 121 is coupled to an external power supply, the charging control section 2001 functions to charge the secondary cell 121 with electric power supplied from the external power supply.

The charging control section 2001 also detects a release of the coupling to the charger 100 of another cart terminal 1 or the power supply device 2. When coupling is released, the charging control section 2001 ends the charging.

The charging control section 2001 also acquires a remaining amount of charge (charge level or charge state) of the secondary cell 121 based on charging state information received from the battery unit 120.

The area determination section 2002 checks whether the cart terminal 1 is within a charging area. In the present example, the cart terminal 1 can be coupled to the power supply device 2 that is installed only in a cart storage area. That is, the area determination section 2002 can identify whether cart terminal 1 is presently within a cart storage area based upon a determination the cart terminal is presently coupled to the power supply device 2.

In some examples, the area determination section 2002 acquires position information indicating the position of the cart terminal 1 via sensor of some type. The area determination section 2002 is an example of a position information acquisition section or a sensor interface. The area determination section 2002 determines whether cart terminal is within a charging area (the cart storage area, in this example) based on the acquired position information.

For example, the area determination section 2002 acquires position information for the cart terminal 1 from a positioning system that uses a beacon signal or the like. More specifically, in this example, the area determination section 2002 controls the near field communication unit 205 to receive (sense or detect) a Bluetooth® beacon signal. In some examples, the area determination section 2002 controls the near field communication unit 205 to acquire position information based on the location of another device that transmits a beacon signal and the received radio signal intensity of the beacon signal. The area determination section 2002 may identify whether the cart terminal is within the cart storage area based on such information.

In some examples, the area determination section 2002 controls the near field communication unit 205 to acquire position information based on placement of a Wi-Fi access point and a MAC (Media Access Control) address contained in data received from the Wi-Fi access point.

In some examples, the area determination section 2002 controls the capturing unit 206 to acquire position information. For example, a store operator may attach two-dimensional codes printed in various colors to the certain parts of the cart storage area. The area determination section 2002 may thus control the capturing unit 206 as a sensor to capture a picture of the two-dimensional codes printed in various colors and thus acquire position information by decoding the captured two-dimensional codes.

In some examples, the area determination section 2002 controls the near field communication unit 205 as a sensor to acquire position information via communication with RF tags in the cart storage area or otherwise. The area determination section 2002 thus controls the near field communication unit 205 to read a RF tag and acquire position information based on the information provided by the RF tag(s) placed in the cart storage area or otherwise.

The mode control section 2003 controls the power supply modes of the cart terminal 1. The power supply modes are modes related to the power consumption of the cart terminal 1. As possible power supply modes, there are, for example, a power saving mode and a normal mode.

The power saving mode reduces the overall power consumption of the cart terminal 1. More specifically, the power saving mode suppresses or stops the functioning or at least one function of at least one sub-unit of the cart terminal 1. For example, the power saving mode reduces the internal clock (operating) frequency of the control unit 201 and powers off the display unit 207 and the scanner 140. In other examples, other power saving methods may be adopted in addition to or instead of those referenced above.

The normal mode is the standard operating mode with power consumption of the various sub-units of cart terminal 1 be set primarily in view of operator convenience. In other words, the normal mode is the mode of executing the functions of the cart terminal 1 with optimal power consumption settings for user convenience rather than power saving. For example, in the normal mode power, power is kept on for the display unit 207 and the scanner 140 and the control unit 201 operates at maximum internal clock speed.

In general, if the area determination section 2002 determines that cart terminal is within the charging area (the cart storage area) based on position information, the mode control section 2003 changes the mode to the power saving mode. In other words, once the cart terminal 1 is identified as entering the charging area by the area determination section 2002, the mode control section 2003 changes the operating mode of the cart terminal 1 to the power saving mode.

Generally, if the cart terminal 1 is not identified as being within the cart storage area by the area determination section 2002, the mode control section 2003 releases the power saving mode and changes to the normal mode. In other words, if the cart terminal 1 exits from the charging area, as determined by the area determination section 2002, the mode control section 2003 changes the mode to the normal mode.

In some examples, if the cart terminal 1 is a power saving mode when in the cart storage area, a customer may wrongly assume that the cart terminal 1 in the power saving mode is not available because power to the display unit 207 has been turned off as part of the power saving mode. In view of such, once charging of the secondary cell 121 is completed, the mode control section 2003 may operate to change the mode to the normal mode from the power saving mode. In the normal mode, the cart terminal 1 can display various images on the display unit 207. The visible display of images on the fully charged cart terminal 1 can reduce the chance that a customer will wrongly assume that the cart terminal 1 is not available or inoperable.

More specifically, in this context, once charging of the secondary cell 121 is completed, the mode control section 2003 determines whether some condition for recovery from the power saving mode to the normal mode has been satisfied. If so, the mode control section 2003 releases the power saving mode and changes the mode to the normal mode.

The condition or conditions for recovery to the normal mode may be set to cover various scenarios. For example, the condition for recovery may be whether the current time is during the business hours of the store in which the cart terminal 1 is being used. If the current time is outside the business hours, the cart terminal 1 is not typically used by any customers, and thus it may be preferable to maintain the power saving mode outside business hours. Once the current time is during business hours, the mode control section 2003 may then change the mode to the normal mode.

In other examples, the condition for recovery to the normal mode may be whether another cart terminal 1 is coupled to the second coupling terminal 112 of the cart terminal 1. In general, a user selects the rearmost cart terminal 1 in a line. Therefore, if another cart terminal 1 behind the cart terminal 1 in line, it will not be selected by the user until no other cart terminals 1 are behind it. Accordingly, a condition for recovery to the normal mode may be that another cart terminal 1 is not coupled to the second coupling terminal 112.

The communication control section 2004 gives a notification of the charging state as supplied by the charging control section 2001. More specifically, the communication control section 2004 controls the notification unit 209 to gives a notification of the present charging state.

For example, if the area determination section 2002 determines that the device is within the cart storage area but the secondary cell 121 is not yet fully charged, as reported by the charging control section 2001, the communication control section 2004 gives a notification that cart terminal 1 is not charged. Thereby, when the cart terminal 1 is within the cart storage area, the operation of the communication control section 2004 reduces the chance a user that will remove the cart from the cart storage area while the secondary cell 121 is not charged.

For example, when the secondary cell 121 is still being charged, the communication control section 2004 controls the notification unit 209 to emit red light. Thereby, the communication control section 2004 gives a notification to users that the secondary cell 121 is still being charged.

Once the charging of the secondary cell 121 is completed, the communication control section 2004 may control the notification unit 209 to emit green light. Thereby, the communication control section 2004 gives a notification to users that the charging of the secondary cell 121 is completed and the cart terminal 1 is ready for use.

In some examples, the communication control section 2004 may give a notification not only by the notification unit 209 but also by another method. For example, the communication control section 2004 may give a notification by displaying an image indicating the charging state on the display unit 207 or give a notification to another device such as a smartphone or a store server.

Next, control processing executed by the cart terminal 1 will be explained.

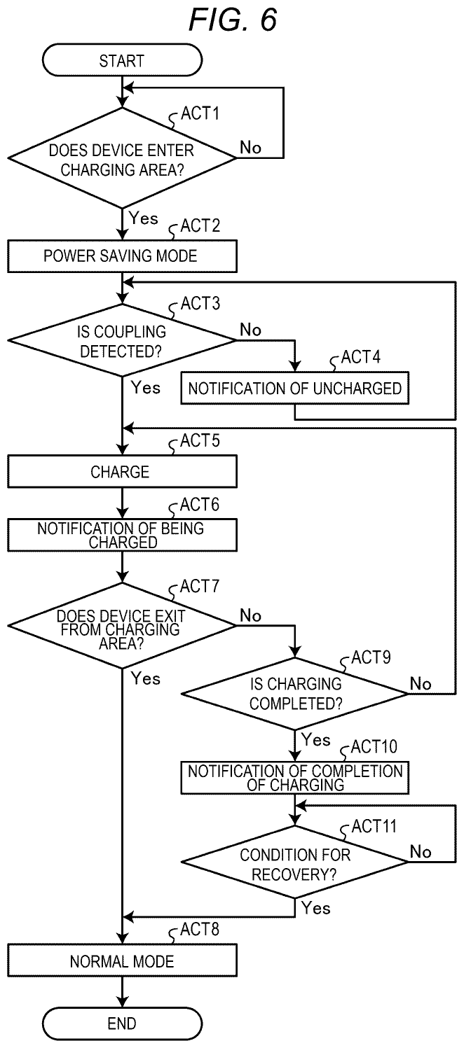

FIG. 6 is a flowchart showing an example of the control processing executed by the cart terminal 1 according to the first embodiment.

The area determination section 2002 determines whether the cart terminal 1 has entered the cart storage area (“charging area”) (ACT 1). That is, the area determination section 2002 checks whether the cart terminal 1 is presently within the cart storage area. If not (ACT 1; No), the area determination section 2002 waits.

When the cart terminal 1 enters the cart storage area (ACT 1; Yes), the mode control section 2003 changes the operating mode to the power saving mode (ACT 2). That is, once the cart terminal 1 is within the cart storage area, the mode control section 2003 changes the mode to the power saving mode.

The charging control section 2001 next determines whether an external power supply (either the power supply device 2 or another cart terminal 1) is coupled to the first coupling terminal 111 (ACT 3). If the external power supply is not coupled to the first coupling terminal 111 (ACT 3; No), the communication control section 2004 gives a notification that cart terminal 1 is not presently charged (ACT 4). Then, the communication control section 2004 returns to ACT 3.

If the external power supply is coupled to the first coupling terminal 111 (ACT 3; Yes), the charging control section 2001 functions to charge the secondary cell 121 with electric power supplied from the external power supply (ACT 5).

The communication control section 2004 gives a notification that the secondary cell is being charged (ACT 6).

The area determination section 2002 determines whether the cart terminal 1 has exited from the cart storage area (ACT 7). That is, the area determination section 2002 checks whether the cart terminal is now outside of the cart storage area. When the cart terminal 1 exits from the cart storage area (“charging area”) (ACT 7; Yes), the mode control section 2003 releases the power saving mode and changes the mode to the normal mode (ACT 8).

If the cart terminal is still within the cart storage area (ACT 7; No), the charging control section 2001 checks whether completion of charging of the secondary cell 121 has been detected (ACT 9). If the charging is not completed (ACT 9; No), the processing returns to ACT 5.

If the charging is completed (ACT 9; Yes), the communication control section 2004 gives a notification of the completion of charging (ACT 10). For example, the communication control section 2004 lights the notification unit 209 to indicate the completion of charging or displays an image indicating the completion of charging on the display unit 207.

The mode control section 2003 checks whether a condition for recovery to the normal mode is satisfied (ACT 11) after charging completion. For example, the mode control section 2003 checks whether the current time is during the business hours of the store.

If the condition for recovery is not satisfied (ACT 11; No), the mode control section 2003 waits. For example, if the current time is outside business hours, the mode control section 2003 waits for the store opening time.

If a condition for recovery is satisfied (ACT 11; Yes), the mode control section 2003 goes to ACT 8. For example, if the time is during the business hours, the mode control section 2003 goes to ACT 8.

In ACT 8, the mode control section 2003 releases the power saving mode and changes the mode to the normal mode.

Here, the cart terminal 1 ends the control processing.

As described above, a cart terminal 1 according to the first embodiment is the cart-type terminal with an operation terminal 200 for registration of merchandise mounted thereon. If the cart terminal 1 is determined to be within the charging area for charging the secondary cell 121, the cart terminal 1 changes its operating mode to a power saving mode for reducing the power consumption by the operation terminal 200 and the like. Thereby, in the cart terminal 1, power consumption may be reduced during charging. Therefore, the cart terminal 1 can be more efficiently charged.

In the first embodiment, the first coupling terminal 111 can be coupled to a power supply device 2 or a second coupling terminal 112 of another cart terminal 1. In other examples, the coupling may be for non-contact charging. That is, the first coupling terminal 111 may accept electric power supply via a non-contact power supply method from a power supply device 2 or a second coupling terminal 112 of another cart terminal 1. That is, the coupling may be indirect or proximity coupling.

A program executed in the above described embodiments and modified examples can be incorporated in a storage medium (ROM or memory unit) in advance and thereby provided. However, the present disclosure is not limited to this method. For example, a program may be recorded as a file in an installable format or executable format in a non-transitory, computer-readable recording medium such as a CD-ROM, a flexible disk (FD), a CD-R, a DVD (Digital Versatile Disk) or the like. Furthermore, a program may be transmitted, accessed, downloaded, distributed, or otherwise provided via network such as a LAN, the Internet, or the like.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A cart-type terminal apparatus, comprising:
an operator terminal for registration of merchandise;
a battery that supplies electric power to the operator terminal;
a charging board configured to charge the battery from an external power source connected to a first coupling terminal; and
a control unit configured to switch an operating mode of the cart-type terminal apparatus from a normal mode to a power saving mode when the cart-type terminal apparatus is determined to be within a charging area.

2. The cart-type terminal apparatus according to claim 1, wherein the control unit is further configured to:
acquire position information indicating a position of the cart-type terminal apparatus, wherein
the control unit is configured to determine the cart-type terminal apparatus is within the charging area based on the position information.

3. The cart-type terminal apparatus according to claim 1, wherein control unit is further configured to:
switch the operating mode to the normal mode from the power saving mode when cart-type terminal apparatus is determined to have left the charging area.

4. The cart-type terminal apparatus according to claim 1, wherein the control unit is further configured to cause a notification to be output indicating a charge level of the battery while the cart-type terminal apparatus is in the charging area.

5. The cart-type terminal apparatus according to claim 1, wherein the control unit is further configured to exit the power saving mode once charging of the battery is completed and a power saving mode exit condition is satisfied.

6. The cart-type terminal apparatus according to claim 5, wherein the power saving mode exit condition is the current time being within business hours.

7. The cart-type terminal apparatus according to claim 1, further comprising:
a barcode scanner connected to the operation terminal.

8. The cart-type terminal apparatus according to claim 7, wherein the power saving mode includes placing the barcode scanner in a low power state.

9. The cart-type terminal apparatus according to claim 1, further comprising:
a notification unit configured to indicate a charge level of the battery while the cart-type terminal is in the charging area.

10. The cart-type terminal apparatus according to claim 1, wherein the power saving mode includes placing a display screen of the operator terminal in a low power state.

11. The cart-type terminal apparatus according to claim 1, wherein the charging board is configured to supply power from the external power source connected to the first coupling terminal to another cart-type terminal connected to a second coupling terminal.

12. A cart-type terminal apparatus, comprising:
a cart;
a cart terminal for registration of merchandise mounted on the cart;
a battery mounted on the cart to supply electric power to the cart terminal;
a first charging terminal on the cart to receive electric power from an external power source and supply power for charging the battery; and
a control unit configured to:
determine whether the cart is in a charging area;
identify a charging state of the battery; and
switch the cart terminal to a power saving mode for reducing power consumption when the cart is in the charging area and the charging state of the battery is below a threshold level.

13. The cart-type terminal apparatus according to claim 12, wherein the control unit is further configured to:
acquire position information indicating a position of the cart-type terminal apparatus, wherein
the control unit is configured to determine the cart-type terminal apparatus is within the charging area based on the position information.

14. The cart-type terminal apparatus according to claim 13, wherein the position information is acquired via a wireless communication unit.

15. The cart-type terminal apparatus according to claim 12, wherein the control unit is further configured to exit the power saving mode when either the cart-type terminal apparatus exits the charging area or charging of the battery is completed and a power saving mode exit condition is satisfied.

16. The cart-type terminal apparatus according to claim 12, further comprising:
a barcode scanner connected to the operation terminal, wherein
the power saving mode includes placing the barcode scanner in a low power state.

17. The cart-type terminal apparatus according to claim 12, further comprising:
a second coupling terminal, wherein
power from the external power source connected to the first coupling terminal is supplied to another cart-type terminal connected to the second coupling terminal.

18. A control method for a cart-type terminal, the control method comprising:
registering merchandise in a sales transaction based on inputs to an operator terminal of a cart-type terminal apparatus;
charging a battery connected to the operator terminal using electric power supplied from an external power source connected to a first coupling terminal of the cart-type terminal apparatus;
identifying whether the cart-type terminal apparatus is within a charging area; and
switching an operating mode of the cart-type terminal apparatus from a normal mode to a power saving mode when the cart-type terminal apparatus is determined to be within the charging area.

19. The control method according to claim 18, further comprising:
exiting the power saving mode once charging of the battery is completed and a power saving mode exit condition is satisfied.

20. The control method according to claim 18, further comprising:
acquiring position information indicating a position of the cart-type terminal apparatus; and
determining whether the cart-type terminal apparatus is within the charging area based on the position information.
